(19) United States
(12) Patent Application Publication
(10) Pub. No.: US 2004/0005268 A1
(43) Pub. Date: Jan. 8, 2004

(54) Method and multi-stage shift reactor for reducing the carbon monoxide content in a hydrogen-containing gas stream, and reformer installation

(76) Inventors: Rolf Bruck, Bergisch Gladbach (DE); Jorg Zimmermann, Bad Munstereifel (DE)

Correspondence Address: LERNER AND GREENBERG, P.A., POST OFFICE BOX 2480, HOLLYWOOD, FL, 33022-2480, US

(21) Appl. No.: 10/441,670

(22) Filed: May 20, 2003

Related U.S. Application Data
(63) Continuation of application No. PCT/EP01/13268, filed on Nov. 16, 2001.

(30) Foreign Application Priority Data
Nov. 20, 2000 (DE) 100 57 420.3

(51) Int. Cl. C01B 31/20

(52) U.S. Cl. 423/437.2; 48/127.9; 48/48; 48/197 R; 48/198.3; 423/247

(57) ABSTRACT

A multi-stage shift reactor reduces a carbon monoxide content in a hydrogen-rich gas mixture stream flowing through the shift reactor in a flow direction. At least two catalyst carrier bodies have a honeycomb structure with passages through which the gas mixture stream can flow and are disposed in succession along the gas mixture stream flow direction. At least one heat exchanger is disposed between the at least two catalyst carrier bodies. Such a shift reactor is particularly suitable for the highly dynamic carbon monoxide conversion in a mobile fuel cell system. A method for reducing a carbon monoxide content in a hydrogen-rich gas mixture stream is also provided.

### CROSS-REFERENCE TO RELATED APPLICATION

This application is a continuation of copending International Application No. PCT/EP01/13268, filed Nov. 16, 2001, which designated the United States and was not published in English.

### BACKGROUND OF THE INVENTION

1. Field of the Invention

The invention relates to a method for reducing the carbon monoxide content in a hydrogen-rich gas mixture stream. The invention also relates to a multi-stage shift reactor for reducing the carbon monoxide content in a hydrogen-rich gas mixture stream, in which the gas mixture stream can flow through the shift reactor in a flow direction. The invention further relates to a reformer installation, in particular in a motor vehicle, for reforming a hydrocarbon-containing gas mixture stream for a fuel cell, including a device for partial oxidation of a hydrocarbon-containing gas mixture stream, a multi-stage shift reactor and an off-gas purification installation. A hydrogen-rich gas mixture stream which has been prepared in such a manner is used, for example, to operate the fuel cell, preferably a mobile fuel cell.

Steam reforming is a known way of reforming a gas stream which contains hydrocarbons or hydrocarbon derivatives such as methanol, for example. Steam reforming is used to generate a hydrogen-rich gas mixture stream. The hydrogen which is obtained is required, for example, to operate a fuel cell installation. However, the steam reforming reactions are substantially endothermic and take place at a reaction temperature which is above room temperature. Therefore, when the reformer installation is being cold-started, steam reforming cannot immediately be used to provide hydrogen, but rather the reformer installation first has to be heated to a suitable operating temperature. It is desirable for it to be possible to produce the required quantity of hydrogen as far as possible without delay, particularly in the case of reformer installations which are operated discontinuously or under differing load conditions. It is necessary to provide sufficient hydrogen as a function of the instantaneous driving power as quickly as possible, particularly where a reformer installation of that type is used in conjunction with a fuel cell installation in a motor vehicle.

There are basically two known chemical reactions for generating a hydrogen-rich gas mixture from a hydrocarbon-containing gas mixture stream:

partial oxidation, and

steam reforming.

In the case of partial oxidation, the hydrocarbon-containing gas mixture stream is burnt with an oxygen-containing gas mixture stream being added. The products which are generated are, inter alia, elemental hydrogen and, as a byproduct, carbon monoxide. In order to operate fuel cells, the carbon monoxide content has to be removed from the gas stream, since fuel cells which are currently known (e.g. PEM fuel cells) only ensure problem-free operation in the presence of very small quantities of carbon monoxide. For example, when a known low-temperature fuel cell is operating, the concentrations of carbon monoxide in the gas stream must not exceed 50 ppm (parts per million). The primary reaction equation involved in the partial oxidation is:

CₘHₙ+m/2 0₂→mCO+n/2 H₂

where CₘHₙ is a hydrocarbon compound, m denotes the number of carbon atoms and n denotes the number of hydrogen atoms. Starting the partial oxidation requires activation energy.

The process then takes place substantially exothermically (with heat being released). The reactions substantially take place in a temperature range from 800° C. to 1300° C.

The reaction equation of steam reforming, depending on the hydrocarbons (CₘHₙ) being used, is:

CₘHₙ+m H₂0⇄m CO+(n/2+m) H₂

The steam reforming is endothermic, i.e. requires energy. The maximum hydrogen yield in that case can be reached at temperatures of from 600° C. to 800° C. The use of catalysts makes it possible to shift that range toward lower temperatures.

However, with a view to being used for a fuel cell, the product gas which is generated with the aid of the methods explained still contains constituents which have to be removed. That is true primarily of products of incomplete reforming, but mainly carbon monoxide. For that purpose, in particular exothermic carbon monoxide conversion or the water gas shift reaction are used. The reaction equation in that context is:

m CO+n H₂0⇄m CO₂+n H₂

Those “shift reactions” mainly take place in a limited part of a reformer installation, which is referred to herein as a “shift reactor”. While in the case of steam reforming a high temperature leads to a high conversion rate of the starting materials and to a high reaction rate, with an increased carbon monoxide content also being generated, the chemical equilibrium of the shift reaction moves in the opposite direction. Those reactions therefore take place more slowly, and consequently the carbon monoxide concentration in the gas mixture stream can no longer be decisively reduced.

Since the processes or methods used to obtain hydrogen and to convert carbon monoxide are highly temperature-dependent, various measures have already been proposed for controlling the temperature in a reformer installation. The following text explains two different methods and devices in more detail.

U.S. Pat. No. 6,132,689, for example, has disclosed a multi-stage, isothermal reactor for carrying out partial oxidation and selective catalytic oxidation of carbon monoxide. The reactor has a multiplicity of catalytically actively coated heat exchangers which are disposed in succession and are connected to one another through a mixing chamber. That reactor, which has a plate-type structure, firstly ensures the, production of hydrogen with the aid of partial oxidation and secondly reduces the carbon monoxide content. Since a rise in the carbon monoxide concentration is observed at excessively high temperatures in the reactor, a coolant flows through the heat exchanger. The heat exchangers are surrounded by a common housing, into which the hydrocarbon-containing gas and oxygen are introduced.

A further method and a further device for the selective catalytic oxidation of carbon monoxide are known, for example, from European Patent EP 0 776 861 B1, corresponding to U.S. Pat. No. 5,874,051, in which it is proposed for the oxidizing gas to be introduced into a carbon monoxide oxidation reactor with quantitative flow control. The heat evolved in the exothermic carbon monoxide oxidation reaction is influenced in a targeted way. Passive cooling of the gas mixture stream with the aid of static mixer structures is proposed for that purpose. European Patent EP 0 776 861 B1, corresponding to U.S. Pat. No. 5,874,051, discloses a plate-type reactor which has any desired number of individual plate reactor modules. Those individual modules are disposed in succession in gas mixture stream flow direction, with a heat-absorbing space being formed between each pair of modules.

A common feature of both reactors is that the reduction of the carbon monoxide content takes place in the immediate vicinity of a heat exchanger with a plate-type structure. In that case, a cooling medium flows through the heat exchanger, since the partial oxidation is known to be an exothermic reaction.

European Patent 0 361 648 B1, corresponding to U.S. Pat. No. 5,030,440, describes a shift reaction which takes place in two stages. In the first stage, the temperature is 350° C. to 500° C., while the temperature within the second stage is 200° C. to 280° C. German Published, Non-Prosecuted Patent Application DE 196 25 093 A1, corresponding to U.S. Pat. No. 6,048,508, and German Published, Non-Prosecuted Patent Application DE 2054 942, corresponding to U.K. Patent 1 325 172, also disclose shift reactors which have a plurality of stages that are at different temperatures and through which the starting gases flow in succession. The cooling between the stages is performed by heat exchangers. Those shift reactors have the drawback that the temperature rises in the direction of flow within a reaction stage. Therefore, since the shift reaction is highly temperature-dependent, precise control of the reaction conditions is not possible.

### SUMMARY OF THE INVENTION

It is accordingly an object of the invention to provide a method, a multi-stage shift reactor and a reformer installation, for reducing the carbon monoxide content in a hydrogen-containing gas stream, which overcome the hereinafore-mentioned disadvantages of the heretofore-known methods and devices of this general type, which enable a hydrogen-rich gas mixture stream of the required purity to be provided quickly and which allow rapid matching of reaction conditions to altered operating conditions.

With the foregoing and other objects in view there is provided, in accordance with the invention, a method for reducing a carbon monoxide content in a hydrogen-rich gas mixture stream. The method comprises conducting the gas mixture stream through at least two catalyst carrier bodies successively disposed along a gas mixture stream flow direction and having a honeycomb structure with passages. A shift reaction is carried out in the catalyst carrier bodies. The gas mixture stream is conducted through at least one heat exchanger disposed between the at least two catalyst carrier bodies.

The method for reducing the carbon monoxide content in a hydrogen-rich gas mixture stream is based on the gas mixture stream flowing through at least two catalyst carrier bodies which are disposed in succession in the direction of flow. The catalyst carrier bodies have a honeycomb structure with passages through which the gas mixture stream flows. As it does so, the exothermic shift reaction described above takes place, with the precise reaction conditions, such as for example the position of the reaction equilibrium, being dependent on the temperature of the gas mixture stream. At least one heat exchanger through which the gas mixture stream flows is disposed at least between the catalyst carrier bodies. This at least one heat exchanger makes it possible to establish a predetermined temperature in the gas mixture stream which can be substantially maintained despite the exothermic nature of the reaction. The honeycomb-like structure of the catalyst carrier bodies offers a very large surface area for a smaller volume as compared, for example, to a plate-type reactor having the same surface area.

With the objects of the invention in view there is also provided a multi-stage shift reactor for reducing a carbon monoxide content in a hydrogen-rich gas mixture stream flowing through the shift reactor in a flow direction. The shift reactor comprises at least two catalyst carrier bodies having a honeycomb structure with passages through which the gas mixture stream can flow. The at least two catalyst carrier bodies are disposed in succession along the gas mixture stream flow direction. At least one heat exchanger is disposed between the at least two catalyst carrier bodies.

It is possible to precisely set a predeterminable temperature over the axial length of the shift reactor with the aid of the at least one heat exchanger. The honeycomb-like configuration of the catalyst carrier bodies provides a very large surface area with which the gas mixture stream comes into contact as it flows through the passages, while at the same time a smaller volume is required as compared to a plate-type structure.

The multi-stage structure of the shift reactor according to the invention is advantageous in particular with regard to the variables which influence the shift reactions. The shift reaction is highly temperature-dependent, and consequently the reaction equilibrium can be influenced through the use of the temperature. The shift reactor, with the aid of the at least one heat exchanger, ensures rapid adjustment to altered temperatures in the gas mixture stream and/or in the shift reactor such as occur, for example, in the event of a cold start or in the event of greatly varying load conditions in the reformer installation. In order for the temperature of the gas mixture stream or of the shift reactor to be determined, the latter preferably has at least one sensor.

In accordance with another feature of the invention, each catalyst carrier body of the multi-stage shift reactor has a unit cross-sectional area with a predeterminable passage density. The passage density per unit cross-sectional area of the catalyst carrier bodies increases in the direction of flow. This means that as the partial pressure of the starting materials decreases, the flow resistance rises, leading to a longer residence time, which promotes the overall conversion rate of the shift reactor. In this context, it is particularly advantageous for the passage density per unit cross-sectional area of the last catalyst carrier body, as seen in the direction of flow, to be greater than 1200 cpsi (cells per square inch), and preferably even greater than 1600 cpsi. In this way, by way of example, a carbon monoxide concentration in the hydrogen-rich gas mixture stream of less than 500 ppm, and if appropriate less than 50 ppm, is achieved.

In accordance with a further feature of the invention, each catalyst carrier body of the multi-stage shift reactor has an area-specific heat capacity. The area-specific heat capacity of the catalyst carrier bodies decreases in the direction of flow. A reduced heat capacity means that only a smaller amount of heat is withdrawn from the gas mixture stream flowing through the off-gas catalyst carrier body. This is advantageous in particular in view of the temperature dependency of the shift reaction. In this context, it should be noted that especially at relatively low temperatures, a slight drop in the reaction temperature leads to a significant shift toward lower reaction rates. A very low area-specific heat capacity of the last catalyst carrier body, as seen in the direction of flow, is particularly advantageous, since the desired temperatures can then be set very accurately.

In accordance with an added feature of the invention, the catalyst carrier bodies have sheet-metal layers, at least some of which are structured in such a way that the gas mixture stream can flow through them. In this case, the sheet-metal layers preferably include metal sheets which have a thickness of less than 0.08 mm. In this context, it is particularly advantageous for the metal sheets of the sheet-metal layers of the last catalyst carrier body, as seen in the direction of flow, to be constructed with a thickness of less than 0.04 mm, in particular less than 0.02 mm. Constructing the catalyst carrier bodies with metallic sheet-metal layers has the advantage of providing very thin passage walls, with the result that it is possible to produce catalyst carrier bodies with very low area-specific heat capacities and a very high passage density.

In accordance with an additional feature of the invention, passages of the catalyst carrier bodies are formed by using sheet-metal layers which preferably include structured and smooth metal sheets. At least one structured and/or smooth metal sheet is constructed with elevations which swirl up the gas mixture stream flowing through the passages. This leads in particular to the formation of stacks of alternating structured and smooth metal sheets which are then coiled or wound into the outer shape of the catalyst carrier body. The elevations at least in some cases extend into the interior of the passages, forming flow edges which cause the gas mixture stream flowing through to be swirled up. This allows particularly good contact to be achieved between the flowing gas mixture stream and the passage walls, on one hand, and also ensures sufficient mixing of the reaction partners in the gas mixture stream on the other hand.

In accordance with yet another feature of the invention, the honeycomb structure of at least one catalyst carrier body has openings through which partial gas mixture streams of adjacent passages can flow. In this way, communicating passages are formed, allowing particularly good mixing of the gas mixture stream. This is particularly advantageous if further gas streams, which include, for example, water or hydrogen, are fed to the gas mixture stream. These water-containing or oxygen-containing gas streams provide the reaction partners which are required in the partial oxidation or the shift reaction to reduce the carbon monoxide content and to generate hydrogen.

In accordance with yet a further feature of the invention, at least one catalyst carrier body has a catalytically active coating, which preferably has a zeolite structure. The use of catalysts shifts the desired reaction rates and equilibria toward lower temperatures, avoiding a high thermal load on the catalyst carrier bodies. In this case, a catalytically active coating constructed with a zeolite structure has a very fissured surface, so that intensive contact between the gas mixture stream and the surface area which has been increased in this way is ensured. Iron oxide and chromium oxides are particularly suitable for high-temperature conversion (approximately 320° C. to 420° C.), while low-temperature conversion (approximately 180° C. to 250° C.) preferably uses copper oxide or zinc oxide catalysts.

In accordance with yet an added feature of the invention, the multi-stage shift reactor has a plurality of heat exchangers and the heat exchangers each have an inlet side. It is advantageous for the inlet sides of the heat exchangers to be disposed alternately with respect to one another in the direction of flow in order to achieve uniform heat exchange with the gas mixture stream. This means that the heat exchangers are disposed in such a way that the introduction of heat into the shift reactor takes place, for example, alternately or distributed over its periphery. In this way, a highly homogeneous temperature distribution is achieved in the gas mixture stream, enabling the chemical conversion processes to be set very accurately.

In accordance with yet an additional feature of the invention, two catalyst carrier bodies, in particular two adjacent catalyst carrier bodies, are at the same temperature level. This means that the temperature in the shift reactor can be controlled by relatively simple control circuits which only have to compare two temperatures to one another. This advantageously simplifies the outlay involved in temperature control.

With the objects of the invention in view there is additionally provided a reformer installation, in particular in a motor vehicle, for reforming a hydrocarbon-containing gas mixture stream for a fuel cell. The reformer installation comprises a device for partial oxidation of the hydrocarbon-containing gas mixture stream, a multi-stage shift reactor according to the invention, and an off-gas purification installation.

Due to the very good cold-start and load-change properties of the multi-stage shift reactor, a reformer installation of this type is eminently suitable for the generation of hydrogen as an energy carrier in a mobile fuel cell. In this context, in accordance with another feature of the invention, the reactor unit is advantageously constructed as part of the off-gas purification installation. The off-gas purification installation lowers the level of components which are harmful to operation of the fuel cell in the gas mixture stream, for example carbon monoxide. Integrating the reactor unit in an off-gas installation allows a very compact reformer installation to be produced.

In accordance with a concomitant feature of the invention, the reactor unit is connected directly downstream, as seen in the direction of flow, of the device for partial oxidation of the hydrocarbon-containing gas stream. Due to the partial oxidation, the gas mixture stream is already heated to such an extent that the shift reaction in the first catalyst carrier body of the shift reactor can take place at an increased reaction rate, virtually immediately after a cold start. This is desirable in particular in connection with mobile reformer installations.

Other features which are considered as characteristic for the invention are set forth in the appended claims.

Although the invention is illustrated and described herein as embodied in a method and a multi-stage shift reactor for reducing the carbon monoxide content in a hydrogen-containing gas stream, and a reformer installation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, longitudinal-sectional view of an embodiment of a shift reactor according to the invention;

FIG. 2 is an enlarged, fragmentary, perspective view of an embodiment of a honeycomb structure;

FIG. 3 is a cross-sectional view through a catalyst carrier body;

FIG. 4 is a fragmentary, cross-sectional view of a honeycomb structure; and

FIG. 5 is a block diagram of an embodiment of a reformer installation with fuel cells.

### DESCRIPTION OF THE PREFERRED EMBODIMENTS

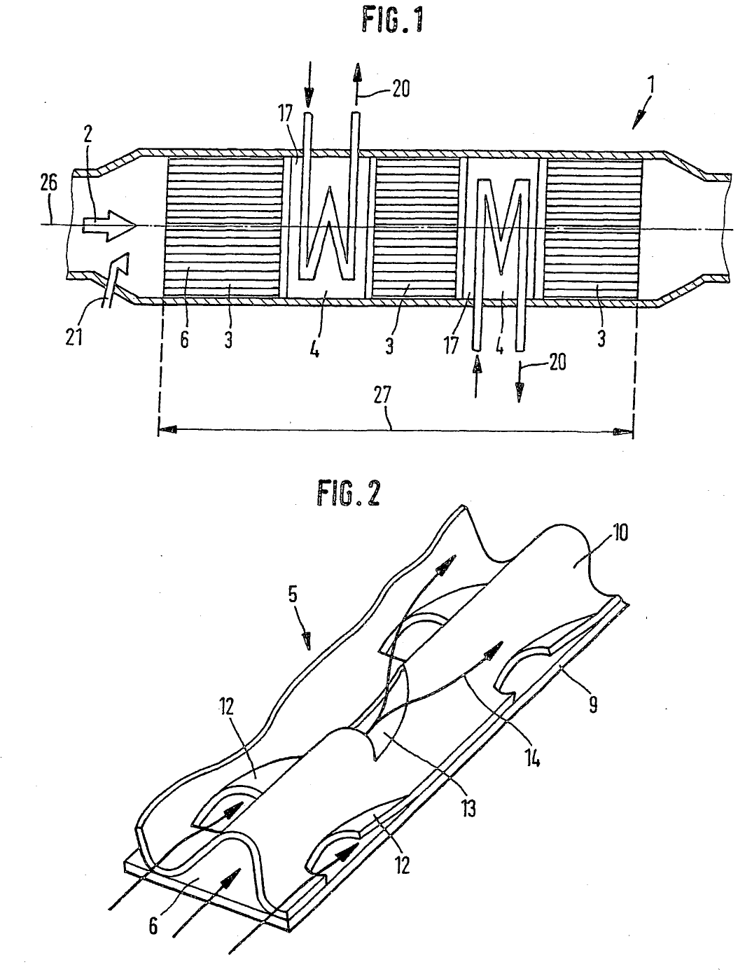

Referring now to the figures of the drawings in detail and first, particularly, to FIG. 1 thereof, there is seen a diagrammatic, longitudinal section of an embodiment of a multi-stage shift reactor 1 according to the invention. The shift reactor 1 has a length 27 in an axial direction 26 and the illustrated embodiment is constructed with three catalyst carrier bodies 3. A respective heat exchanger 4 is disposed between each two of the catalyst carrier bodies 3. A gas mixture stream flows through the shift reactor 1 in a direction of flow 2 and the catalyst carrier bodies 3 have passages 6 through which the gas mixture stream flows. A nozzle 21 is disposed upstream of a first one of the catalyst carrier bodies 3. A water-containing or oxygen-containing gas stream, by way of example, can be introduced through the use of the nozzle 21. The heat exchangers 4 each have an inlet side 17, through which a medium 20 is introduced into an interior of the shift reactor 1. The illustrated embodiment of the shift reactor 1 shows an alternating configuration of the heat exchangers 4, with the inlet sides 17 of the heat exchangers 4 being disposed on opposite sides.

A shift reactor 1 of this type can be operated, for example, in such a manner that the temperature remains substantially constant over the entire length 27 of the shift reactor 1. For this purpose, the length of an individual catalyst carrier body 3 and of a heat exchanger 4 which follows it in the direction of flow 2 must be dimensioned in such a way that, as seen in the direction of flow 2, a temperature increase caused by an exothermic shift reaction as the gas mixture stream flows through the catalyst carrier body 3 is so low that it is eliminated again as a result of the gas mixture stream flowing through the subsequent heat exchanger 4. As a result, the entire shift reactor 1 has uniform reaction conditions. Furthermore, the possibility of rapidly changing the temperature of the entire shift reactor 1 in order, for example, to allow rapid load change operations, is advantageous. If the shift reactor 1 is operated as a high-temperature shift reactor, the temperature is in a range of from 320° C. to 420° C. over the entire length 27, while for a low-temperature shift reaction it is approximately 180° C.

FIG. 2 shows a diagrammatic, perspective view of an embodiment of a honeycomb structure 5 of a catalyst carrier body 3. The honeycomb structure 5 forms the passages 6 through which partial gas mixture streams 14 can flow. The honeycomb structure 5 is formed with smooth metal sheets 9 and structured metal sheets 10. The structured metal sheets 10 are constructed in this case with elevations 12 and openings 13, so that the partial gas mixture streams are swirled up and mixed with one another.

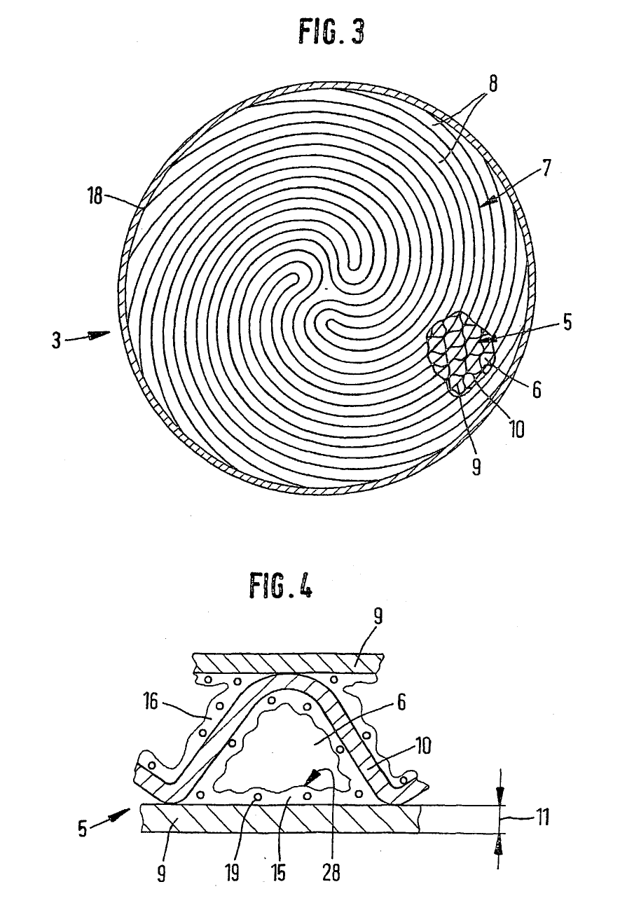

FIG. 3 shows a sectional view through a catalyst carrier body 3 which is constructed with coiled and wound sheet-metal layers 8. The honeycomb structure 5 having the passages 6 is formed in this case by an alternating configuration of the smooth metal sheets 9 and the structured metal sheets 10. The catalyst carrier body 3 has a unit cross-sectional area 7 and the sheet-metal layers 8 are surrounded by a tubular casing 18.

FIG. 4 shows an enlarged, sectional view of a further configuration of the honeycomb structure 5. The honeycomb structure 5 is formed with smooth metal sheets 9 and structured metal sheets 10, in such a way that it has passages 6. The metal sheets 9 and 10 have an active coating 15 with a catalyst 19 and a zeolite structure 16. The result is that a highly reactive surface 28 is formed, with which the gas flowing through the passages 6 comes into contact. The metal sheets 9 and 10 are constructed with a thickness 11 which is less than 0.08 mm.

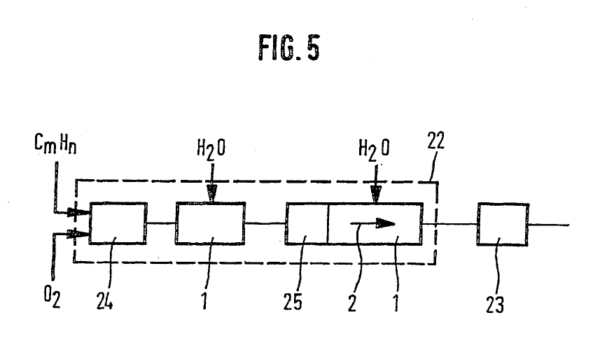

FIG. 5 shows a block diagram of a reformer installation 22. In this case, a hydrocarbon-containing gas stream (CₘHₙ) and an oxygen-containing gas stream (O₂) are first of all fed to a device 24 for partial oxidation. During combustion of these two gas streams, a hydrogen-rich gas mixture stream is generated, which is fed in the downstream direction to a shift reactor 1 according to the invention. Water is additionally added to the gas mixture stream, in order to effect the desired shift reaction. In the downstream direction 2, the shift reactor 1 is adjoined by an off-gas purification installation or exhaust cleaning installation 25, which likewise includes a shift reactor 1. Residual quantities of carbon monoxide in the gas mixture stream are eliminated therein. The particularly pure hydrogen-rich gas generated in this manner is fed to a fuel cell 23 which uses the hydrogen that has been made available to generate energy. A reformer installation of this type is particularly suitable for installation in motor vehicles, since it is distinguished by an especially good light-off and load-change performance.

We claim:

1. A method for reducing a carbon monoxide content in a hydrogen-rich gas mixture stream, which comprises:
conducting the gas mixture stream through at least two catalyst carrier bodies successively disposed along a gas mixture stream flow direction and having a honeycomb structure with passages;
carrying out a shift reaction in the catalyst carrier bodies; and
conducting the gas mixture stream through at least one heat exchanger disposed between the at least two catalyst carrier bodies.

2. A multi-stage shift reactor for reducing a carbon monoxide content in a hydrogen-rich gas mixture stream flowing through the shift reactor in a flow direction, the shift reactor comprising:
at least two catalyst carrier bodies having a honeycomb structure with passages through which the gas mixture stream can flow, said at least two catalyst carrier bodies disposed in succession along the gas mixture stream flow direction; and
at least one heat exchanger disposed between said at least two catalyst carrier bodies.

3. The multi-stage shift reactor according to claim 2, wherein each of said catalyst carrier bodies has a unit cross-sectional area with a passage density, and said passage density per unit cross-sectional area of said catalyst carrier bodies is increased in the gas mixture stream flow direction.

4. The multi-stage shift reactor according to claim 3, wherein said passage density per unit cross-sectional area of said catalyst carrier body disposed farthest downstream in the gas mixture stream flow direction, is greater than 1200 cpsi.

5. The multi-stage shift reactor according to claim 3, wherein said passage density per unit cross-sectional area of said catalyst carrier body disposed farthest downstream in the gas mixture stream flow direction, is greater than 1600 cpsi.

6. The multi-stage shift reactor according to claim 2, wherein each of said catalyst carrier bodies has an area-specific heat capacity, and said area-specific heat capacity of said catalyst carrier bodies is decreased in the gas mixture stream flow direction.

7. The multi-stage shift reactor according to claim 2, wherein said catalyst carrier bodies have sheet-metal layers, and at least some of said sheet-metal layers are structured to permit the gas mixture stream to flow through said structured sheet-metal layers.

8. The multi-stage shift reactor according to claim 7, wherein said sheet-metal layers are constructed with metal sheets having a thickness of less than 0.08 mm.

9. The multi-stage shift reactor according to claim 8, wherein said metal sheets of said sheet-metal layers of said catalyst carrier body disposed farthest downstream in the gas mixture stream flow direction have a thickness of less than 0.04 mm.

10. The multi-stage shift reactor according to claim 8, wherein said metal sheets of said sheet-metal layers of said catalyst carrier body disposed farthest downstream in the gas mixture stream flow direction have a thickness of less than 0.02 mm.

11. The multi-stage shift reactor according to claim 7, wherein said sheet-metal layers include structured metal sheets and smooth metal sheets forming said passages, and at least one of said metal sheets is constructed with elevations swirling up the gas mixture stream flowing through said passages.

12. The multi-stage shift reactor according to claim 2, wherein said honeycomb structure has openings through which partial gas mixture streams of adjacent passages can flow.

13. The multi-stage shift reactor according to claim 2, wherein at least one of said catalyst carrier bodies has a catalytically active coating.

14. The multi-stage shift reactor according to claim 13, wherein said catalytically active coating has a zeolite structure.

15. The multi-stage shift reactor according to claim 2, wherein said at least one heat exchanger is a plurality of heat exchangers each having an inlet side, and said inlet sides of said heat exchangers are disposed alternately with respect to one another in the gas mixture stream flow direction for achieving uniform heat exchange with the gas mixture stream.

16. The multi-stage shift reactor according to claim 2, which further comprises a nozzle for introducing a gas stream selected from the group consisting of a water-containing gas stream and an oxygen-containing gas stream.

17. The multi-stage shift reactor according to claim 16, wherein said nozzle is disposed upstream of said catalyst carrier body disposed farthest upstream in the gas mixture stream flow direction.

18. The multi-stage shift reactor according to claim 2, wherein said at least two catalyst carrier bodies include two catalyst carrier bodies at the same temperature level.

19. The multi-stage shift reactor according to claim 18, wherein said two catalyst carrier bodies at the same temperature level are mutually adjacent.

20. A reformer installation for reforming a hydrocarbon-containing gas mixture stream for a fuel cell, the reformer installation comprising:
a device for partial oxidation of the hydrocarbon-containing gas mixture stream;
a multi-stage shift reactor according to claim 2; and
an off-gas purification installation.

21. The reformer installation according to claim 20, wherein said multi-stage shift reactor is part of said off-gas purification installation.

22. The reformer installation according to claim 20, wherein said multi-stage shift reactor is connected directly downstream of said device for partial oxidation of the hydrocarbon-containing gas mixture stream, in flow direction of the gas mixture stream.

23. In a motor vehicle having a fuel cell, a reformer installation for reforming a hydrocarbon-containing motor vehicle gas mixture stream for the fuel cell, the reformer installation comprising:
a device for partial oxidation of the hydrocarbon-containing motor vehicle gas mixture stream;
a multi-stage shift reactor according to claim 2; and
an off-gas purification installation.
